(19) United States
(12) Patent Application Publication
(10) Pub. No.: US 2021/0108444 A1
(43) Pub. Date: Apr. 15, 2021

(54) SCREWLESS STRIKE ASSEMBLY FOR A LOCK

(71) Applicant: BONAITI SERRATURE S.P.A., Calolziocorte (IT)

(72) Inventor: Luigi Bolognesi, Calolziocorte (IT)

(21) Appl. No.: 16/496,716

(22) PCT Filed: Apr. 4, 2018
(86) PCT No.: PCT/IB2018/052321

§ 371 Date: Sep. 23, 2019

(30) Foreign Application Priority Data
Apr. 5, 2017 (IT) 102017000037622

(51) Int. Cl. E05B 15/02; E05C 19/16; E05B 17/20

(52) U.S. Cl. CPC E05B 15/0205; E05C 19/163; E05B 2047/0069; E05Y 2900/132; E05B 17/2038

(57) ABSTRACT

A screwless strike assembly for a lock includes a box body provided with side wall elements that bound a cavity that is suitable for receiving a latch or a bolt of the lock. The box body is suitable for being positioned in a housing seat of a frame of a door or another support element. The assembly includes a front plate, provided with a passage opening for the latch or bolt, and formed according to the geometrical shape of the box body. The assembly is provided with elements for fixing in the housing seat. The fixing elements include one or more locking arms integrally obtained on, and protruding from the rear of front plate, and elastically yieldable from a rest configuration to a spreadable fixing configuration in which they engage a bounding surface of the housing seat. The box body includes one or more pushing surfaces configured for spreading and pressing one or more locking arms against the bounding surface to achieve the spreading fixing configuration.

### CROSS-REFERENCE TO RELATED APPLICATIONS

This application is a § 371 National Stage Entry of PCT/IB2018/052321 filed Apr. 4, 2018 entitled “Screwless Strike Assembly for a Lock.” PCT/IB2018/052321 claims priority to IT-102017000037622 filed Apr. 5, 2017. The entire content of these applications are incorporated herein by reference in their entireties.

### BACKGROUND OF THE INVENTION

The present invention relates to a screwless strike assembly for latch or bolt locks, of both magnetic and non-magnetic type, the assembly comprising a box body and a front plate having respectively a cavity and an opening for receiving and engaging the latch or the bolt of the lock. The assembly is configured for being firmly secured, without screws, in a housing seat of the fixed frame of a door, or another support element.

Striking devices for locks are known that comprise a flat striking plate having one or more openings for engaging the latch and/or the bolt of a lock, in which holes are obtained on the plate that receive corresponding screws for fixing the plate to the fixed wooden frame of a door.

The screws, whatever the orientation thereof with respect to the striking plate, are in view and this gives the plate an aesthetic appearance that is hardly pleasing.

The presence of screws can further entail other drawbacks: in particular the screws make the assembly operations more laborious and costly, and in addition a screw that is possibly tightened incorrectly or partially can accidentally come into contact with a person, causing harm to that person.

Striking devices of the mentioned type are for example known from U.S. Pat. No. 4,854,622 and US 2016/069105.

Another type of striking device, known for example from DE2921201, US451700 and IT 1377400, provides a front plate that is integral with a cup body, which are configured for permitting engagement with the latch and/or the bolt of a lock.

The cup body can be further provided with a cavity for receiving a magnet. The striking device is, also in this case, connected to the fixed frame by screws, in a similar manner to a conventional striking plate.

Striking devices have also been proposed to overcome partially the problems discussed above. In particular, in order to anchor the contrasting device to frames or supports of reduced thickness, it has been proposed to configure the cup body with inner or outer holes, for the fixing screws, suitably tilted, as for example disclosed in U.S. Pat. Nos. 3,392,998, 4,186,954, US2008/0265590, EP2248968 and AU561724.

According to these solutions, the fixing screws can be positioned inside the cup body; despite this, such screws are not yet completely hidden, so the problem of the aesthetic appearance is still not sufficiently solved.

According to another solution, disclosed in EP2475831, a body is provided that defines a receiving seat for the latch and on which expanding wings are received integrally, which, by means of screws, are divaricated to determine the fixing thereof in the seat of the fixed frame. Also in this case, the problem continues to exist of the complexity and laboriousness of fitting due to the presence of the screws, which cannot unfortunately be dispensed with.

### SUMMARY OF THE INVENTION

One object of the present invention is to find a new and different solution for a striking device for locks, which is suitably configured for being fixed in a housing seat of the wooden frame of a door or another support element, without using screws or particular tools.

In particular, one object is to provide a strike assembly that is simply configured structurally that enables easy and immediate fixing to the frame and is at the same time pleasing from the aesthetic point of view.

Another object is to provide a strike assembly that does not require extremely precise machining of the housing seat and at the same time enables possible clearance and machining tolerances of the housing seat to be compensated, ensuring solid anchoring of the striking element.

In particular, according to the invention, a screwless strike assembly for a lock is provided, which include a box body provided with side wall elements that bound an inner cavity that is suitable for receiving and engaging a latch or a bolt of the lock, the box body being suitable for being positioned in a housing seat of a frame of a door or another support element. A front plate provided with a passage opening for the latch or bolt, is configured for conforming to, and coupling with, the box body. Fixing elements are provided for fixing the assembly in the housing seat. The fixing elements include one or more locking arms integrally obtained on, and protruding from the rear of the front plate, the one or more locking arms being elastically yieldable from a rest configuration to a spreadable fixing configuration that they engage with a bounding surface of the housing seat, the box body including one or more pushing surfaces configured for spreading and pressing the one or more locking arms of the front plate against the bounding surface to achieve the spreadable fixing configuration.

### BRIEF DESCRIPTION OF THE DRAWINGS

These and further features of the strike assembly can be better understood and implemented owing to the following description and with reference to the drawings that show different simplified embodiments, in which:

FIG. 1 shows a first embodiment of the screwless strike assembly according to the invention, with the box body and the front plate in a disassembled condition;

FIG. 2 is a perspective view of the strike assembly in an assembled condition;

FIG. 3 is a rear perspective view of another front plate embodiment;

FIGS. 4 and 5 are respectively side views of the box body and of the front plate of the first assembly embodiment of FIG. 1;

FIGS. 6 and 7 are respectively a side view and a top view of the assembly of FIG. 1 in an assembled condition;

FIG. 8 is a front view of the assembly of FIG. 1;

FIG. 9 is a cross section taken along the plane IX-IX in FIG. 8;

FIG. 10 is a longitudinal section taken along the plane X-X in FIG. 8, which shows the assembly fitted in a housing seat of a fixed frame for a door;

FIG. 10A is an enlarged detail of FIG. 10;

FIG. 11 shows a second embodiment of the screwless strike assembly according to the invention, with the box body and the front plate in a disassembled condition;

FIGS. 12 and 13 are respectively a front perspective view and a rear perspective view of the second strike assembly embodiment in an assembled condition;

FIG. 14 is another front perspective view of the second strike assembly embodiment;

FIGS. 15 and 16 are respectively side views of the box body and of the front plate of the second assembly embodiment of FIG. 11;

FIG. 17 is a side view of the embodiment of FIG. 11 in an assembled condition;

FIG. 18 is a front view of the assembly of FIG. 11;

FIG. 19 is a cross section taken along the plane XIX-XIX of FIG. 18;

FIG. 20 is a longitudinal section taken along the plane XX-XX of FIG. 18 that shows the second assembly embodiment fitted in the housing seat;

FIG. 21 is a top view of the assembly of FIG. 18;

FIGS. 22 and 23 show a third strike assembly embodiment respectively in a perspective view in a disassembled condition and in a front view in an assembled condition;

FIG. 24 is a longitudinal section taken along the plane XXIV-XXIV in FIG. 23;

FIG. 25 is a cross section taken along the plane XXV-XXV in FIG. 23;

FIG. 26 is a bottom view of FIG. 23;

FIG. 27 shows the front plate of the third strike assembly embodiment;

FIGS. 28 to 30 are different views of the box body of the third strike assembly embodiment;

FIG. 31 shows a fourth embodiment of the screwless strike assembly according to the invention, with the box body and the front plate in a disassembled condition;

FIG. 32 is a perspective view of the fourth strike assembly embodiment in an assembled condition;

FIGS. 33 and 34 are respectively side views of the box body and of the front plate of the fourth assembly embodiment of FIG. 31;

FIG. 35 is a side view of the assembly of FIG. 31 in an assembled condition;

FIG. 36 is a front view of the assembly of FIG. 31 in an assembled condition;

FIG. 37 is a longitudinal section taken along the plane XXXVII-XXXVII in FIG. 36 that shows the strike assembly in the housing seat of the fixed frame;

FIGS. 38 and 39 are other views of the fourth embodiment of the strike assembly in an assembled condition;

FIG. 40 is a perspective view of a fifth strike assembly embodiment in an assembled condition;

FIG. 41 is a longitudinal section that shows the fifth strike assembly embodiment fixed in the housing seat;

FIG. 42 is a front view of the fifth strike assembly embodiment in an assembled condition;

FIG. 43 is a cross section taken along the plane XLIII-XLIII in FIG. 42;

FIG. 44 is a top view of the strike assembly in FIG. 42.

### DETAILED DESCRIPTION

With reference to the attached figures, some embodiments of the screwless strike assembly according to the invention are disclosed in greater detail, the screwless strike assembly being suitable for being positioned in a housing seat 5 of a fixed frame of a door or another support element.

The strike assembly is configured with fixing elements, disclosed in detail below that enable the strike assembly to be securely and easily fixed to the housing seat 5 without the use of any screw or other distinct equivalent fixing element.

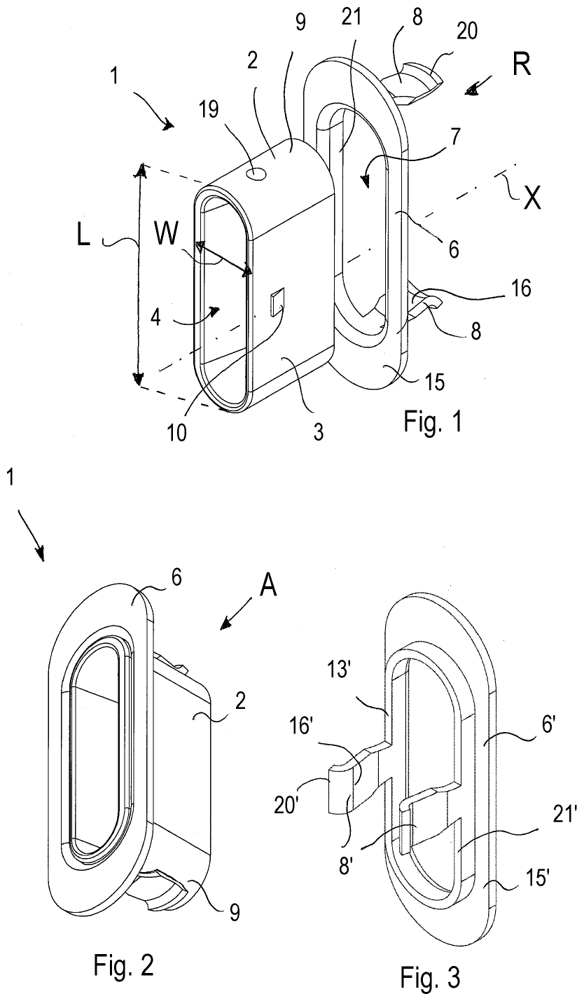

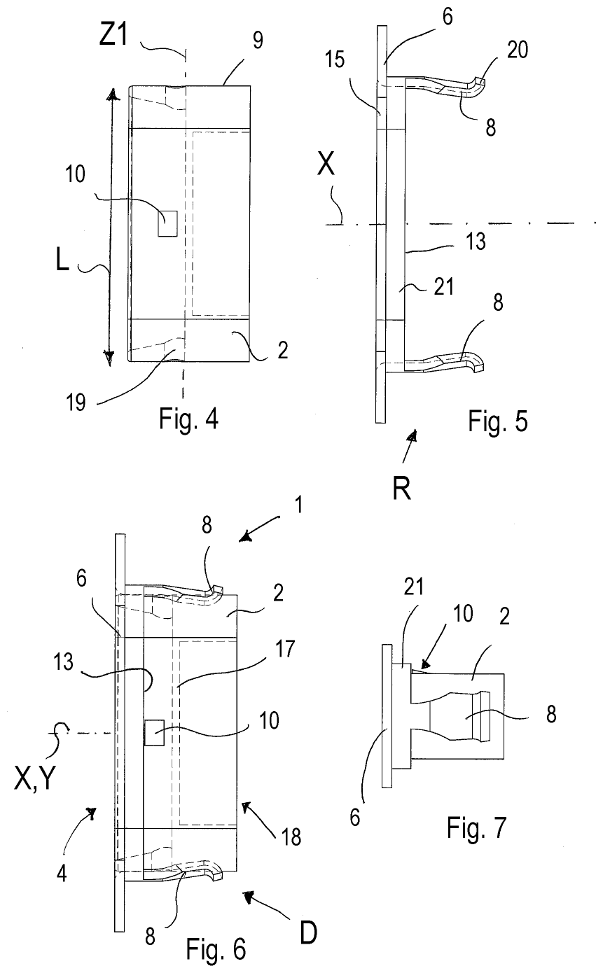

A first embodiment of a strike assembly 1 is shown in FIGS. 1-2, and 4-10A.

The strike assembly 1 comprises a box body 2 and a front plate 6, which are distinct from one another and reciprocally couplable in an assembled configuration A by pressure insertion of box body 2 into the housing seat 5 through a passage opening 7 of the front plate 6.

The box body can be made by plastic moulding, or be obtained in a zinc-based metal alloy, or another equivalent material. The front plate is made of metal such as iron, stainless steel, or brass, for example by blanking and drawing or another process, or can be made by plastic moulding, or can be made partly of metal and partly of plastics.

The box body 2 has an elongated shape and extends with a length L along a first longitudinal axis Z1 and with a width W along a second transverse axis Z2.

The front plate 6 also has an elongated shape and is geometrically shaped to conform to the respective box body 2.

It is not ruled out that the box body 2 and thus also the front plate 6 can have other geometrical shapes, other than that disclosed here and shown in the Figures, both with reference to this first assembly embodiment 1 and with reference to the other embodiments disclosed further below.

In the embodiment disclosed here by way of example, the box body 2 has a cup shape and is bounded externally by peripheral surfaces and rounded ends that conform to the housing seat obtained in the frame of the door.

The box body 2 comprises side walls 3 that bound internally a cavity 4 that is suitable for receiving and engaging a latch or a bolt of the lock.

In particular, the cavity 4, of elongated shape, is open at the front and extends longitudinally between the two rounded ends of the box body 2.

The box body 2 comprises a bottom wall 17 arranged transversely to the side walls 3 to bound the depth dimension of the cavity 4 that is internal and open frontally.

If the strike assembly 1 has to engage locks with a magnetic latch or bolt, the box body 2 can be optionally provided with a rear recess 18 that is suitable for containing a permanent magnet that is suitable for interacting with the latch or bolt of the magnetic lock.

In other words, the rear recess 18 is defined on the part opposite to the cavity 4 with respect to the bottom wall 17.

The front plate 6 comprises a flat base portion 15, intended to be in view during normal use, covering the edges of the housing seat 5.

In the embodiment disclosed here and shown in the figures, in particular, the flat base portion 15 is embedded in the wood of the frame, i.e. is so housed in the seat that the outer front surface thereof is flush, i.e. continues on the same plane, with the outer surface of the frame that houses the flat base portion 15. Nevertheless, according to another fitting configuration, it is possible to provide for the base portion 15 being slightly raised compared with the outer surface of the frame that houses the base portion 15.

The strike assembly 1 is provided with locking arms 8, integrally obtained on, and protruding to the rear from, the front plate 6, intended for penetrating inside the housing seat 5, and configured for acting as elements for fixing the assembly to the housing seat 5.

In particular, two locking arms 8 are provided (but it is also possible to configure the assembly 1 with a different number of locking arms) that project transversely and from the rear of the aforesaid base portion 15.

The two locking arms 8 are positioned at opposite ends with respect to a median axis X of the front plate 6 that is orthogonal to the lying plane of said flat base portion 15.

In particular, the two locking arms 8 project from respective opposite edge zones bounding the passage opening 7 and face one another.

More precisely, the two locking arms 8 extend along respective directions that are oriented in a substantially mutually convergent manner but are intended to be divaricated, during the assembly step, by the box body 2 against the bounding surface S of the housing seat 5.

The locking arms 8 are elastically yieldable from a rest configuration R, shown in FIG. 1, to a divaricated fixing configuration D, in which they engage the bounding surface S of the housing seat 5 as shown in FIG. 10.

The box body 2 comprises externally two opposite pushing surfaces 9 configured for divaricating and pressing the respective locking arms 8 of the front plate 6 against the bounding surface S to reach the divaricated fixing configuration D that is more visible in FIG. 10.

The locking arms 8, in the embodiment of FIG. 1, are obtained at opposite ends on the respective short sides of the front plate 6.

The pushing surfaces 9 are convex towards the exterior and the locking arms 8, in the embodiment that is disclosed and shown by way of non-limiting example, have a cross section with an inner concave profile for coupling with and embracing better, in the assembled configuration A, the aforesaid pushing surfaces 9.

The locking arms 8 each comprise a yielding surface 16, facing the aforesaid median axis X and arranged for coming into contact with and receiving a pressing action from the respective pushing surface 9 of the box body 2.

The locking arms 8 are elastically flexible and spreadable through the effect of the action of the pushing surfaces 9—transversely and moving away from the median axis X, to reach the divaricated fixing configuration D.

In order to perform the assembly operation, once the front plate 6 has been positioned with the flat base portion 15 applied along the outermost edge of the housing seat 5 and with the locking arms 8—still the rest configuration R—penetrating the housing seat 5, the box body 2 is introduced through the passage opening 7 along an insertion direction coinciding with, or parallel to the median axis X of the front plate 6.

The locking arms 8, initially in the rest configuration R, i.e. oriented in a mutually convergent manner, go into contact with the respective pushing surfaces 9 of the box body 2 being inserted and are divaricated therefrom in a centrifugal direction, i.e. transversally to the insertion direction and away from the median axis X, thus towards the adjacent zones of the surface S that bounds the housing seat 5 of the fixed frame.

Each locking arm 8 is provided, at the free end, with a curved grasping portion 20, having sharp edges, and/or toothing and/or ribbing, and/or pointed protrusions suitable for penetrating, or generating a great friction force against the inner bounding surface S of the housing seat 5.

The locking arms 8, or in one case only the yielding surfaces 16, in the rest configuration R are oriented in a more or less accentuated mutually convergent manner on the geometry of the grasping ends 20 or curved grasping portions 20 of the locking arms 8 or of other geometries of the front plate 6 and/or of the box body 2.

In one version, shown in FIG. 3, the front plate, indicated by 6′, is provided with locking arms 8′ that are positioned on the long sides rather than on the short sides. In this case, the pushing surfaces that divaricate the locking arms 8′ are supplied by the wall portions that define the long sides of the box body. These pushing surfaces are in this case flat and the locking arms 8′ have cross sections with substantially rectangular profiles. For the rest, the front plate 6′ comprises characteristics that are identical to the front plate 6 already disclosed and indicated by the same reference number but in superscript.

The strike assembly according to the invention can be configured for enabling the position of the cavity 4 to be adjusted with respect to the position that the latch or the bolt adopts when the door is abutting on the frame in the closed position, in this manner enabling possible fitting imprecisions, misalignments to be corrected and/or possible play of the latch or bolt to be recovered.

More precisely, the geometrical configuration of the box body 2 is such that the cavity 4 for receiving and engaging the latch or bolt is off-centre or misaligned by a certain quantity Q with respect to a central axis Y of the box body 2. In equivalent terms, in the assembled configuration, the cavity 4 is misaligned by the quantity Q with respect to the median axis X of the front plate 6.

With X′ a median axis is indicated of the cavity 4 that extends in the depth direction, and which is misaligned by the Q with respect to the median axis X of the front plate 6.

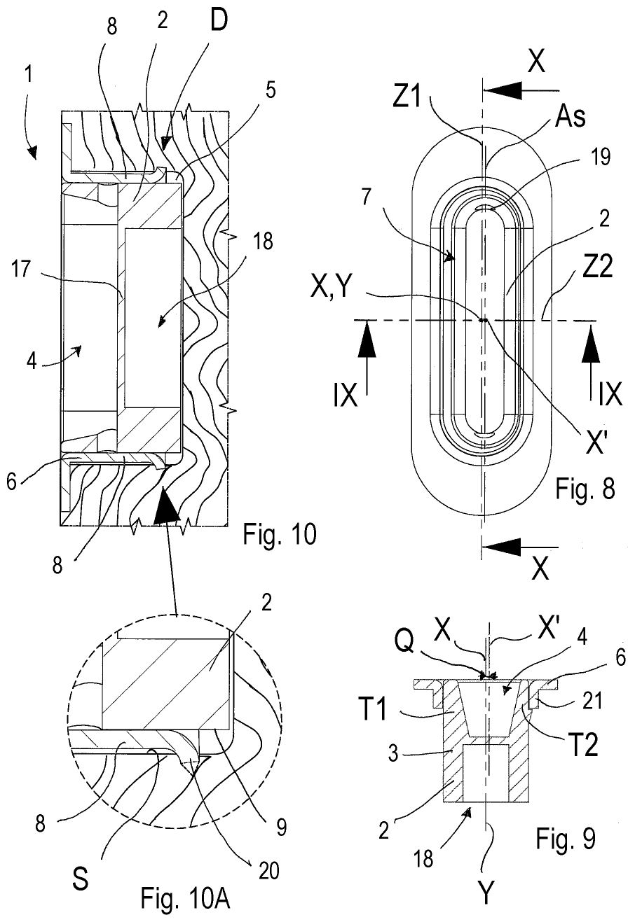

In equivalent terms, it can be said that the cavity 4 is shaped with a longitudinal axis with symmetry A_{S} parallel to and spaced apart from the first longitudinal axis Z1 of the box body 2, as shown in FIG. 8.

As can be noted in FIG. 9, the box body 2 has, on the long sides, the two opposite walls 3 with thicknesses that are different from one another.

Precisely, a first side wall portion T1 is provided with a greater thickness and an opposite second side wall portion T2 having a lesser thickness is provided.

The two wall portions T1 and T2 have thicknesses that are different from one another starting from the outermost zone that surrounds the opening edge of the cavity 4; the two thicknesses, subsequently, increase along the depth direction of the cavity 4, always maintaining themselves different from one another until the bottom surface of the cavity 4 is reached.

The box body 2 can then be fitted in the housing seat 5 in a first position or, by rotating the box body 2 by 180° around the central axis Y, in a second position so as to have double possible positioning of the cavity 4—adjustable transversely to the inlet direction of the latch/bolt, in the width direction of the housing seat 5—to adapt to/align itself on the latch/bolt. The box body 2 that is thus configured is reversible, i.e. is of the reversible type, i.e. fittable in two different positions owing to the misaligned position of the cavity 4 with respect to the remaining body.

The strike assembly 1 that is thus configured clearly enables processing or fitting imprecisions of the fixed frame, of the housing seat 5 and of the lock which includes the latch and/or the bolt, to be remedied easily and immediately.

The strike assembly 1 is provided with protruding retaining elements 10 by means of which the box body 2 and the front plate 6 are maintained mutually and stably coupled in the assembled configuration A.

The retaining elements comprise one or more snap hooking teeth 10, each protruding externally, with a ramp shape, from the side wall 3 of the box body 2 and arranged for engaging a rear surface 13 of the front plate 6. In particular, the rear surface 13 is obtained on a protruding annular edge 21 obtained on the flat base portion 15 and bounding the passage opening 7.

When the box body 2 is inserted into the passage opening 7 of the front plate 7, the contraction elastic deformation in the transverse direction of the side wall 3 or possibly also joined with an enlarging elastic deformation in the transverse direction of the annular edge 21 of the plate means that the hooking tooth 10 can pass the annular edge 21, positioning itself behind the annular edge 21 and being arranged in snap contact with the rear surface 13. In this manner the box body 2 is hooked securely and stably to the front plate 6, which in turn, by the gripping action of the locking arms 8, is firmly secured to the housing seat 5. If it is desired to remove the strike assembly 1 from the housing seat 5, it is sufficient, with a simple screwdriver or similar tool, to flex, towards the centre of the cavity 4, the side wall 3 on which the hooking tooth 10 is present and pull the box body 2 outwardly.

Once the box body 2 has been removed, it is possible to extract easily also the front plate 6.

In order to facilitate the removal of the box body 2, on the side wall 3, in particular on the short side at the portion of the curved wall, an extraction recess 19 can be obtained that is suitable for engaging with the tip of a tool for drawing and extracting the box body 2 from the housing seat 5.

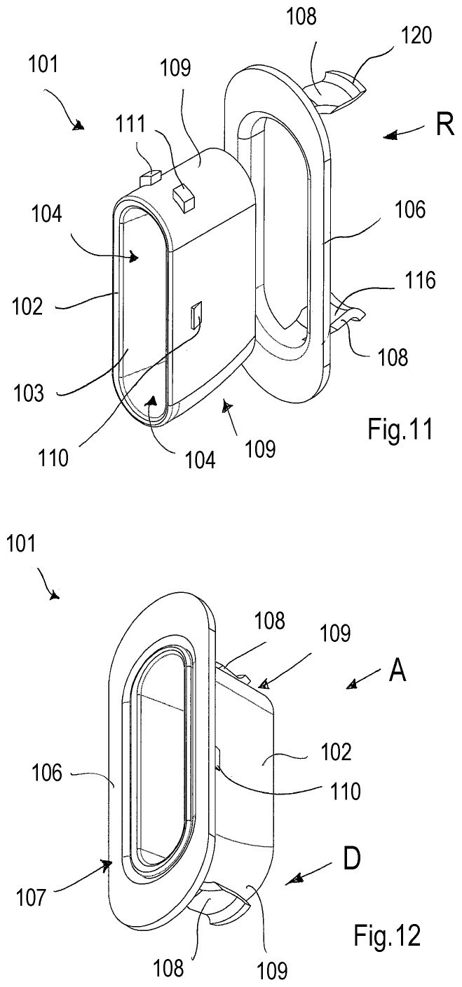

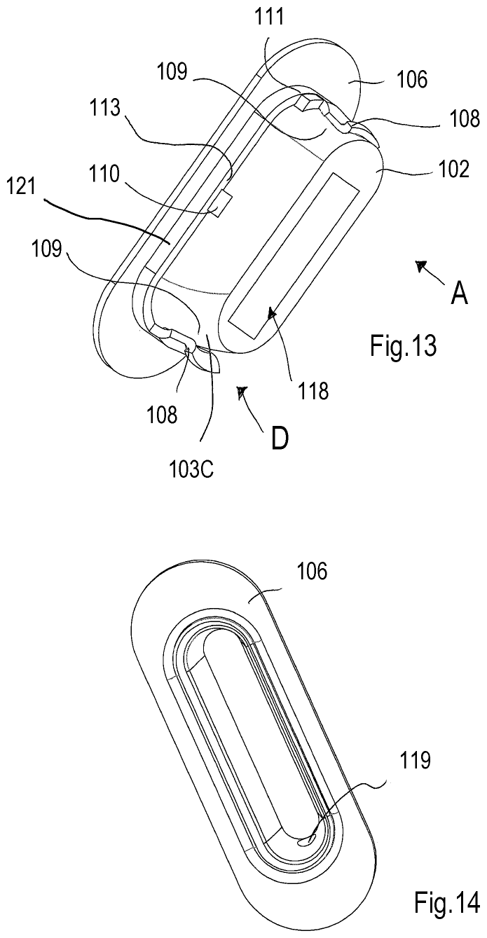

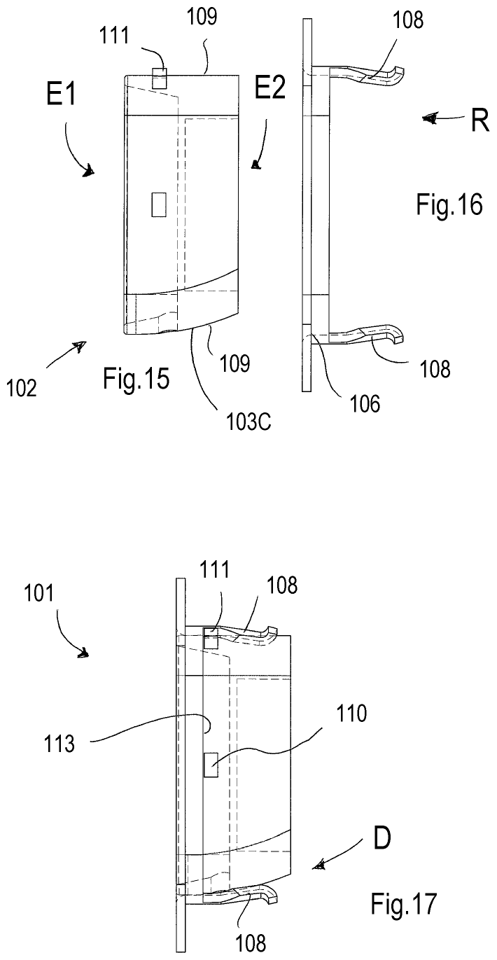

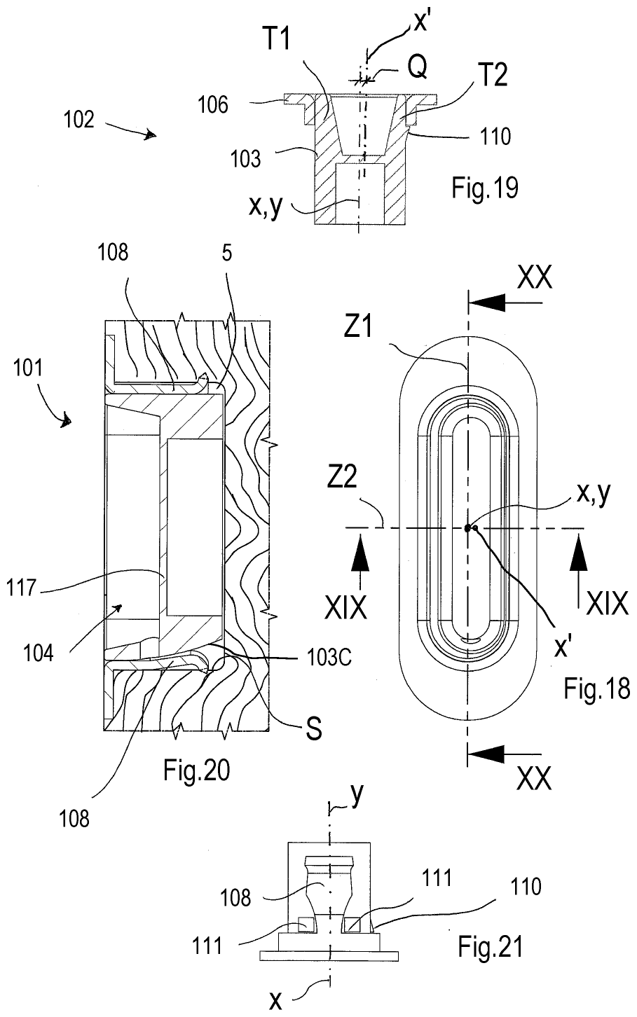

In FIGS. 11 to 21 a second embodiment of screwless strike assembly is shown, indicated in general by number 101. The parts that are common or equivalent to the first embodiment that has just been disclosed are indicated by the same reference numbers but increased by 100.

The strike assembly 101 differs from the first embodiment disclosed above inasmuch as the box body 102 is tapered from a front end E1 to a rear end E2. In other words, the rear bottom of the box body 102 has a reduced extent with respect to the front section, and the centre of the rear bottom is misaligned with respect to the central axis of the frontal section.

In particular, with reference to FIG. 20, the upper edge of the rear bottom is at the same height as the corresponding upper edge of the frontal section of the body 102, whereas the lower edge of the rear bottom is at a greater height than the corresponding lower edge of the frontal section.

A part of wall 103C that joins the lower edge of the front section to the lower edge of the rear bottom curves upwards to enable the box body 102 to be inserted by rotation into the passage opening 107 of the front plate 106.

In this second embodiment, the retaining elements comprises, in addition to one or more hooking teeth 110 located on the long side of the wall 103, also a pair of engaging teeth 111 arranged at one end of the box body 102.

The engaging teeth 111 are shaped and positioned to engage adjacent zones located to the sides of the locking arm 108 of the front plate 106.

The engaging teeth 111 act as lever points on the front plate 106 during insertion of the box body 102 into the passage opening 107 and thus into the housing seat 5 of the fixed frame.

During fitting, once the front plate 106 is positioned against the housing seat 5 similarly to what has already been disclosed for the first embodiment, the box body 102 is introduced through the passage opening 107, this time first in a tilted position, i.e. with the opening of the cavity 104 facing slightly upwards, so as to position first the engaging teeth 111 behind the rear surface 113 of the front plate 106, and engage the engaging teeth 111 with the aforesaid zones adjacent to the sides of the locking arm 108.

At this point, with the engaging teeth 111 in contact with the annular rear surface 113 of the front plate 106 and acting as a lever point or fulcrum, the box body 102 can be rotated inside the housing seat 5 through the passage opening 107.

During this insertion of rotational type, the pushing surfaces 109 divaricate the respective locking arms 108 against the bounding surface S of the housing seat 5, determining the fixing of the front plate 106 to the frame. Lastly, the reaching by the hooking tooth 110 of the engagement position behind the surface 113 of the annular edge 121 determines stable coupling of the box body 102 with the front plate 106.

Also in this second embodiment, the box body 102 is asymmetrical, i.e. the cavity 104 is shaped with a longitudinal axis of symmetry that is parallel to and spaced apart from the first longitudinal axis Z1 of the box body 102 as in the first embodiment. In this manner, with the misaligned cavity 104, the reversibility in two different fitting positions is provided, similarly to the first embodiment.

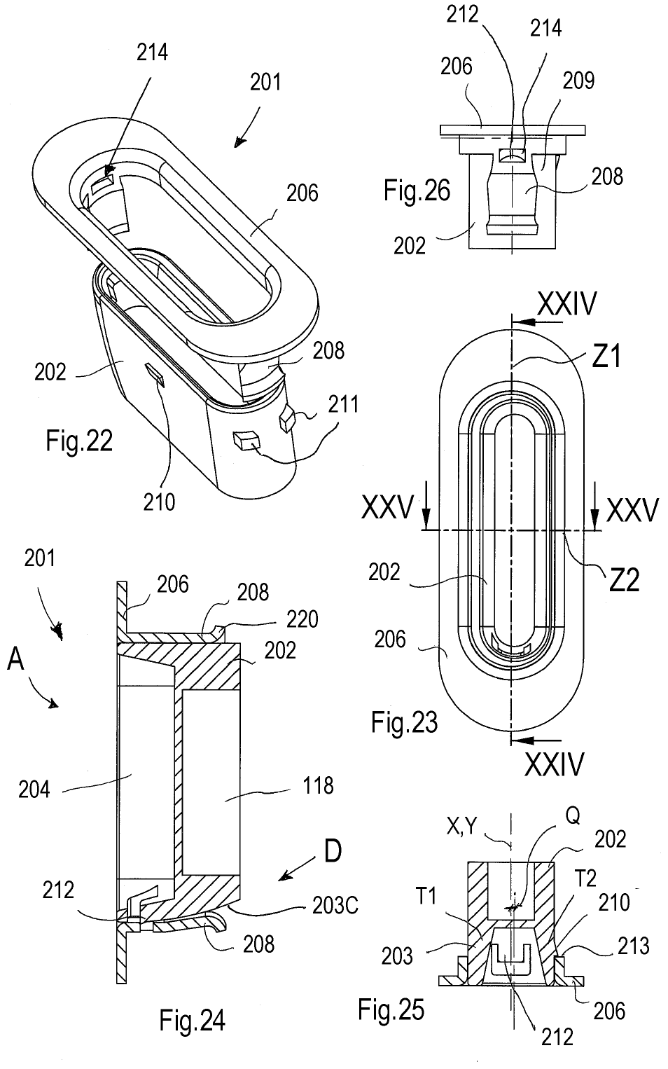

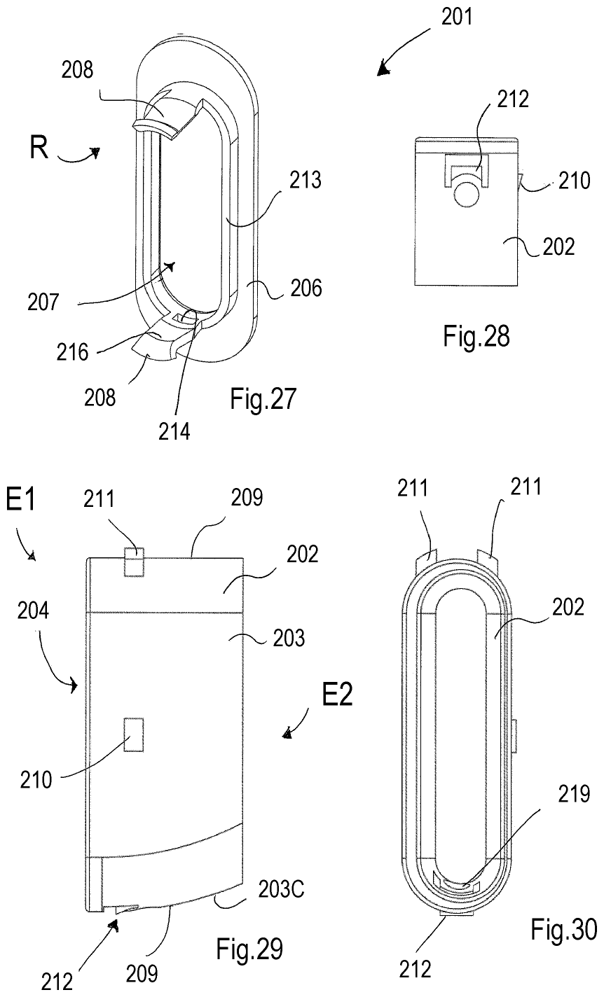

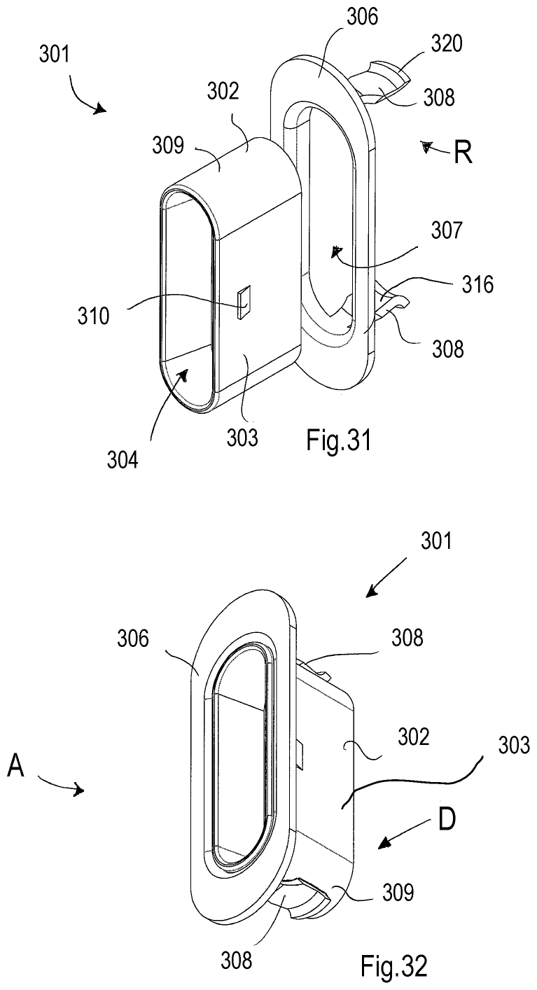

FIGS. 22 to 30 show a third strike assembly embodiment indicated in general by number 201. The parts that are common or equivalent to the second embodiment that has just be disclosed are indicated by the same reference numbers but increased by 100.

The strike assembly 201 differs from the preceding embodiments inasmuch as the retaining elements also comprises an end hooking tooth 212 placed on the short side of the box body 202 in a position opposite the engaging teeth 211.

In the embodiment disclosed with reference to FIGS. 22 to 30, a sole hooking tooth 212 is visible. Nevertheless, in an embodiment not shown, several hooking teeth can be provided.

The hooking tooth 212 is shaped as a ramp and protrudes outside the side wall 203. The end hooking tooth 212 is bounded, on three sides, by through notches so as to be cantilevered and flexible with respect to the wall 203 on which it is obtained.

On one of the locking arms 208 an arm hooking slit 214 is obtained that is suitable for engaging the hooking tooth 212.

Also in this third assembly embodiment 201, the box body 202 is provided with engaging teeth 211 that act as a fulcrum and with a curved wall 203C for inserting the box body 202 by rotation into the housing seat 5, identically to the second embodiment above.

The notches that bound the hooking tooth 212 can be exploited, by a simple screwdriver or equivalent tool, to flex temporarily the hooking tooth 212 inside the cavity 204 to permit possible removal of the box body 202 from the housing seat 5.

Also in this third embodiment 201, the box body 202 is provided with walls with a different thickness that define a misaligned cavity 204, to provide reversibility in two different fitting positions, thus as already seen for the first and second embodiment.

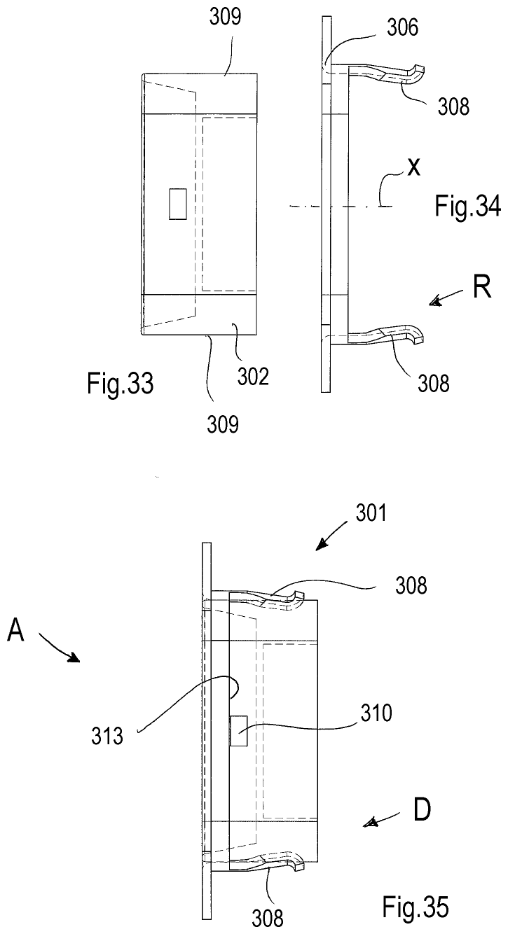

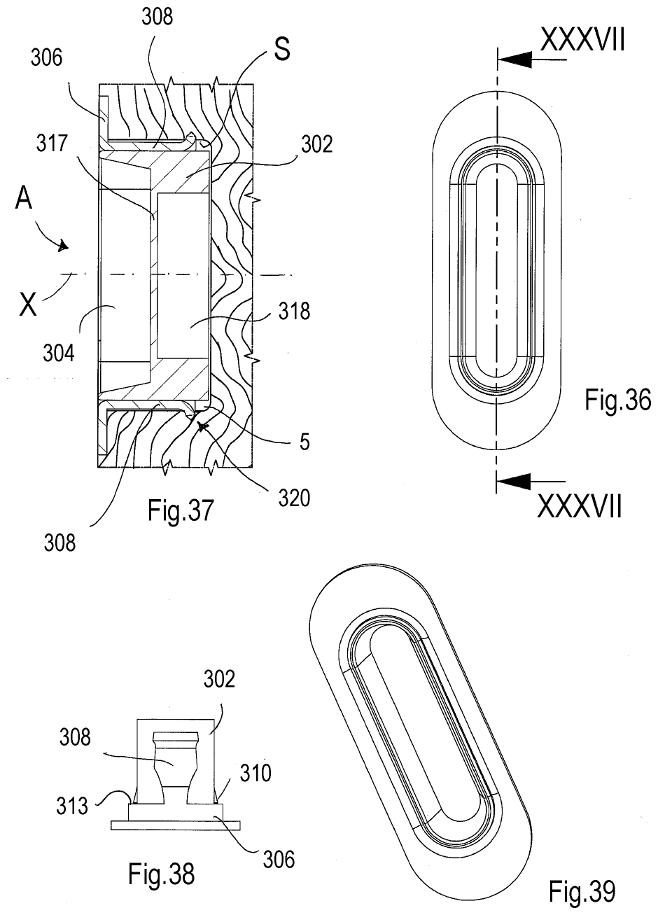

FIGS. 32 to 39 show a fourth strike assembly embodiment, indicated in general by reference number 301, very similar to the first embodiment of FIG. 1, but structurally simplified. In particular, the box body 301 is not of reversible type, i.e. does not have the misaligned configuration of the cavity 304, which is on the other hand distributed symmetrically and centred on the box body 302.

The thicknesses of the opposite side walls 303 are thus the same as one another. Also the extraction recess 19 is thus absent, which on the other hand appears in the first assembly embodiment.

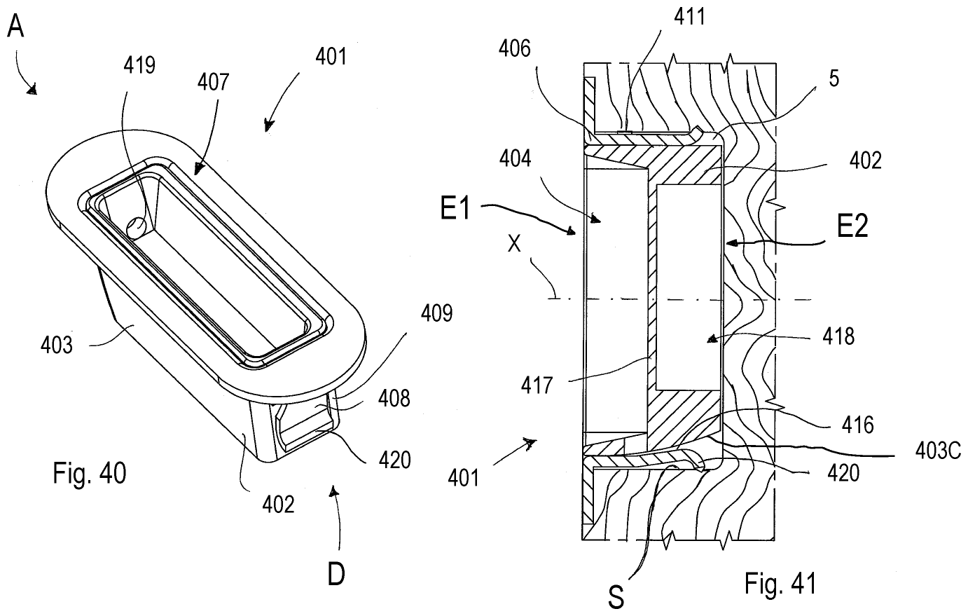

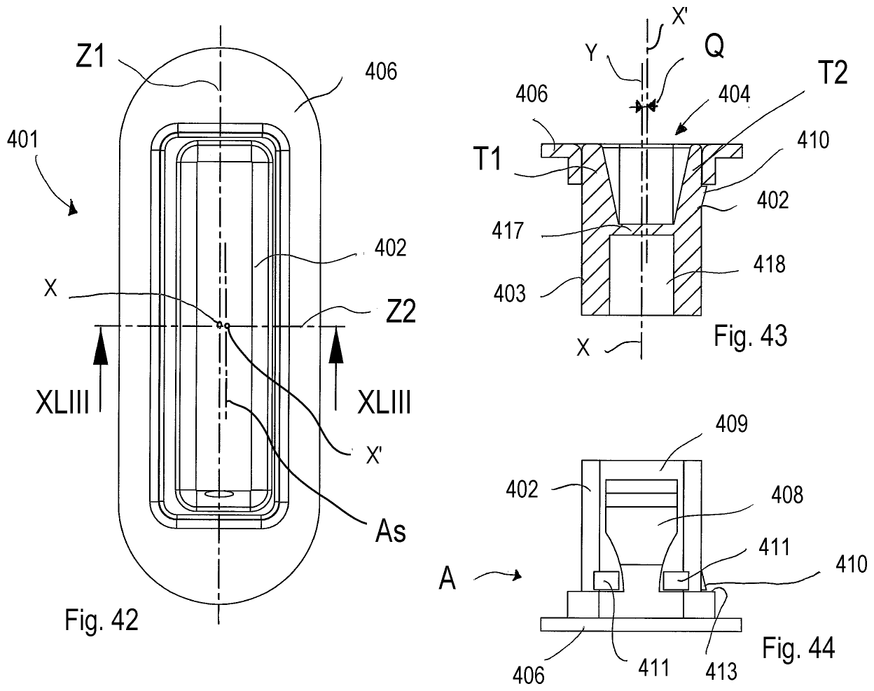

FIGS. 40 to 44 show a fifth screwless strike assembly embodiment, indicated in general by reference number 401, which differs from the preceding embodiments because of the substantially rectangular shape of the plan section of the box body 402. Also the passage opening 407 of the front plate 406 has a substantially rectangular shape with reduced connecting spokes between the long sides and the short sides of the edges. Also the plan section of the cavity 404 for the latch/bolt is substantially rectangular.

The box body 402 is configured with side walls 403 having, in the zone adjacent to the cavity 404, different thicknesses, to provide the assembly 401 with the fitting reversibility similarly to the preceding embodiments.

The box body 402, like assembly embodiments 101 and 201, is provided with engaging teeth 411, and is tapered and provided with a curved side wall 403C inserting the box body 402 into the housing seat 5 by rotation, similarly to what was disclosed previously for other embodiments.

From what has been disclosed above and shown with attached Figures, it is thus clear that a strike assembly has been provided for a lock with latch or conventional bolt or lock of magnetic type, that is able to eliminate totally the need for screws for fixing to the wooden fixed frame, thus achieving extreme constructional simplification of the entire strike assembly.

The total elimination of the fixing screws, in addition to constructionally simplifying the device, also enables the device to be applied easily in frames or support elements of reduced thickness.

To the advantage of general constructional simplification, the associated advantage is added of comparatively reduced costs and the advantage of having a significantly improved aesthetic appearance compared with known devices.

The particular laterally misaligned arrangement of the frontal cavity of the box body also enables possible misalignments with the bolt or the latch of the lock to be remedied easily and possible machining tolerances of the housing seat to be compensated.

Modifications can be made to the strike assembly, or to parts thereof, without thereby falling outside the scope of the claims.

In practice, the materials, inasmuch as they are compatible with the specific use and with the respective single components for which they are intended, can be chosen suitably according to the required requirements and according to the available prior art.

It is further possible to configure and size the assembly and use materials according to need and variations on and/or additions to what has been disclosed above and illustrated in the attached drawings are possible.

1. A screwless strike assembly for a lock, comprising:
a box body provided with side wall elements that bound an inner cavity that is suitable for receiving and engaging a latch or a bolt of the lock, said box body being suitable for being positioned in a housing seat of a frame of a door or another support element,
a face plate, provided with a passage opening for said latch or bolt, and configured for conforming to, and coupling with, said box body,
fixing elements for fixing said assembly in said housing seat,
wherein said fixing elements comprises one or more locking arms that are integrally obtained on, and protrude from the rear of, said face plate, said one or more locking arms being elastically yieldable from a rest configuration to a divaricated fixing configuration in which they engage a bounding surface of said housing seat, said box body comprising one or more pushing surfaces configured for divaricating and pressing said one or more locking arms of said face plate against said bounding surface to achieve said divaricated fixing configuration.

2. A screwless strike assembly according to claim 1, wherein said box body and said face plate are distinct from one another and are mutually couplable in a reciprocally assembled configuration by press-fitting of said box body into said passage opening of said face plate.

3. A screwless strike assembly according to claim 1, comprising protruding retaining elements by means of which said box body and said face plate are reciprocally maintained stably coupled in the assembled configuration.

4. A screwless strike assembly according to claim 3, wherein said retaining elements comprises one or more snap hooking teeth protruding with a form of ramp from said side wall elements and suitable for engaging a rear surface of said face plate.

5. A screwless strike assembly according to claim 3, wherein said retaining elements comprises a pair of engaging teeth arranged at one end of said box body and shaped for engaging zones adjacent to a locking arm of said face plate.

6. A screwless strike assembly according to claim 3, wherein said retaining elements comprise an end hooking tooth, shaped as a ramp and protruding from said side wall elements and suitable for engaging a hooking slit obtained on a respective locking arm, said end hooking tooth being bounded by through notches to be flexibly connected in a cantilevered manner to said side wall elements.

7. A screwless strike assembly according to claim 1, wherein said face plate comprises a flat base portion, and said one or more locking arms project transversely and from behind from said base portion according to respective substantially mutually converging directions, such that said one or more locking arms, in use, result penetrating inside said housing seat and are intended to be divaricated by said box body against the bounding surface of said housing seat.

8. A screwless strike assembly according to claim 7, wherein said box body is shaped for being inserted, through said passage opening, into said housing seat along an insertion direction substantially parallel to a median axis of said face plate that is orthogonal to the lying plane of said flat base portion.

9. A screwless strike assembly according to claim 8, wherein said one or more locking arms are elastically flexible, and spreadable through the effect of the push of said one or more pushing surfaces, transversely to said insertion direction, away from said median axis, to reach said divaricated fixing configuration.

10. A screwless strike assembly according to claim 9, wherein said one or more locking arms project from respective edge zones bounding said passage opening, and each comprise a yielding surface facing said median axis and arranged for coming into contact and receiving a pressing action from a respective pushing surface obtained externally on said box body.

11. A screwless strike assembly according to claim 1, wherein said box body has an elongated shape and extends by a length along a first axis and by a width along a second axis, said face plate also being of elongated shape to conform to said box body and being provided with two locking arms arranged at opposite ends with respect to said passage opening.

12. A screwless strike assembly according to claim 1, wherein each of said one or more locking arms comprises a curved grasping end with sharp edges, and/or toothing and/or ribbing, and/or pointed protrusions suitable for penetrating, or generating a great friction force against the inner bounding surface of said housing seat.

13. A screwless strike assembly according to claim 1, wherein said box body has a cup shape and comprises a bottom wall arranged transversely to said side wall elements for bounding the depth of said cavity.

14. A screwless strike assembly according to claim 13, wherein said box body is tapered from a front end towards a rear end, a part of said side wall elements joining orthogonally said bottom wall whereas another part of said side wall elements is curved and tilted with respect to said bottom wall to enable said box body to be inserted by rotation into said passage opening of said face plate.

15. A screwless strike assembly according to claim 13, wherein in said box body a rear recess is obtained that is suitable for housing a magnet for interacting with a latch of a magnetic lock, said rear recess being defined at a side opposite said cavity with respect to said bottom wall.

16. A screwless strike assembly according to claim 1, wherein said side wall elements comprise, on mutually opposite sides, wall portions with thicknesses that are different from one another, said cavity being axially misaligned by an amount in relation to a central axis of said box body to enable the position of said cavity to be adjusted with respect to said housing seat.

17. A screwless strike assembly according to claim 1, wherein said side wall elements comprises a first side wall portion having a first thickness and a second portion of side wall opposite said first side wall portion and having a second thickness that is greater than said first thickness, said box body being fittable in said housing seat in a first position or in a second position, rotated, with respect to said first position, by 180° around the central axis of said box body, to adapt/align the position of said cavity to the latch or bolt of a lock.

18. A screwless strike assembly according to claim 1, wherein said cavity is shaped with a longitudinal axis of symmetry parallel to and spaced apart from the respective longitudinal axis of said box body.

19. A screwless strike assembly according to claim 1, wherein on said side wall elements one or more extraction recesses are obtained that are configured for engaging with a tool to extract said box body from said housing seat.
